(19) United States
(12) Patent Application Publication
(10) Pub. No.: US 2018/0082656 A1
(43) Pub. Date: Mar. 22, 2018

(54) INFORMATION PROCESSING APPARATUS, INFORMATION PROCESSING METHOD, AND PROGRAM

(71) Applicant: SONY CORPORATION, TOKYO (JP)

(72) Inventors: TOMOYUKI ITO, KANAGAWA (JP); TAKEO TSUKAMOTO, TOKYO (JP); TAKASHI ABE, TOKYO (JP); SHUICHI KONAMI, CHIBA (JP)

(73) Assignee: SONY CORPORATION, TOKYO (JP)

(21) Appl. No.: 15/560,182

(22) PCT Filed: Mar. 3, 2016
(86) PCT No.: PCT/JP2016/056668

§ 371 Date: Sep. 21, 2017

(30) Foreign Application Priority Data
Apr. 22, 2015 (JP) 2015-087332

(51) Int. Cl. G09G 5/00; G02B 27/01; G06K 9/00

(52) U.S. Cl. CPC G09G 5/003; G02B 27/0172; G06K 9/00604; G09G 2354/00; G02B 2027/0138; G02B 2027/014; G02B 2027/0178

(57) ABSTRACT

[Object] To enable a user to use a head mounted device in a more preferable manner.

[Solution] An information processing apparatus including: an acquisition unit configured to acquire a sensing result from a sensing unit that senses information relating to a holding state of a predetermined device, by a holding portion for holding the device, directly or indirectly, with respect to at least a part of a head of a user; and a detection unit configured to detect a deviation between the holding state of the device and a predetermined holding state set in advance, on the basis of the acquired sensing result.

### TECHNICAL FIELD

The present disclosure relates to an information processing apparatus, an information processing method, and a program.

### BACKGROUND ART

In recent years, various devices such as personal computers (PCs), which can be used worn on a part of a user's body, aside from so-called stationary type devices that are installed and used at a desired place, have become common. As devices that a user uses worn on a part of his or her body in this way, devices used worn on the head, such as a head mounted display (HMD) and eyewear-type (i.e., glasses-type) wearable devices, for example, (hereinafter these devices may be referred to as “head mounted devices”) have been proposed. For example, Patent Literature 1 discloses one example of an HMD.

### CITATION LIST

### Patent Literature

Patent Literature 1: JP 2004-96224A

### DISCLOSURE OF INVENTION

### Technical Problem

Among the head mounted devices described above, there are some that hold a predetermined device, such as a display unit (e.g., a display) or an imaging unit, which is used to execute a provided function, such that the predetermined device has a predetermined positional relationship with respect to at least a predetermined part (such as an eye, for example) of the head.

On the other hand, a head mounted device is not always worn in an assumed wearing state. There are also cases where the head mounted device is worn on the head in a state that deviates from the assumed wearing state, as with so-called slippage of glasses. In a state in which such slippage has occurred, a predetermined device such as a display unit or an imaging unit may not always be held so as to have a predetermined positional relationship with respect to a predetermined part such as an eye, and consequently, it may be difficult for the head mounted device to correctly execute a function that uses the predetermined device.

With respect to such a problem, it is conceivable to prevent so-called slippage by securely fixing the head mounted device to the head, but doing so may make it more difficult to get the head mounted device on and off, and may reduce the comfort when the head mounted device is worn.

Therefore, the present disclosure proposes an information processing apparatus, an information processing method, and a program which enable a user to use a head mounted device in a more preferable manner.

### Solution to Problem

According to the present disclosure, there is provided an information processing apparatus including: an acquisition unit configured to acquire a sensing result from a sensing unit that senses information relating to a holding state of a predetermined device, by a holding portion for holding the device, directly or indirectly, with respect to at least a part of a head of a user; and a detection unit configured to detect a deviation between the holding state of the device and a predetermined holding state set in advance, on the basis of the acquired sensing result.

Further, according to the present disclosure, there is provided an information processing method including, by a processor: acquiring a sensing result from a sensing unit that senses information relating to a holding state of a predetermined device, by a holding portion for holding the device, directly or indirectly, with respect to at least a part of a head of a user; and detecting a deviation between the holding state of the device and a predetermined holding state set in advance, on the basis of the acquired sensing result.

Further, according to the present disclosure, there is provided a program causing a computer to execute: acquiring a sensing result from a sensing unit that senses information relating to a holding state of a predetermined device, by a holding portion for holding the device, directly or indirectly, with respect to at least a part of a head of a user; and detecting a deviation between the holding state of the device and a predetermined holding state set in advance, on the basis of the acquired sensing result.

### Advantageous Effects of Invention

As described above, the present disclosure proposes an information processing apparatus, an information processing method, and a program which enable a user to use a head mounted device in a more preferable manner.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory view for explaining an example of the general configuration of a head mounted device.

FIG. 2 is block diagram of an example of a functional configuration of a head mounted device according to an embodiment of the present disclosure.

FIG. 3 is an explanatory view for explaining an example of a way of using the head mounted device according to the embodiment.

FIG. 4 is a flowchart illustrating an example of the flow of a series of processes in the head mounted device according to the embodiment.

FIG. 5 is an explanatory view for explaining an example of a head mounted device according to Example 1.

FIG. 6 is an explanatory view for explaining another example of the head mounted device according to Example 1.

FIG. 7 is an explanatory view for explaining another example of the head mounted device according to Example 1.

FIG. 8 is an explanatory view for explaining an overview of a head mounted device according to Example 2.

FIG. 9 is an explanatory view for explaining another mode of the head mounted device according to Example 2.

FIG. 10 is an explanatory view for explaining an example of control following a detection result of slippage, in the head mounted device according to Example 2.

FIG. 11 is an example of a hardware configuration of the head mounted device according to the embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that the description will be given in the following order.

1. Example of external appearance of head mounted device
2. Functional configuration

### 3. Processes

### 4. Examples

4.1. Example 1: Example of application to a head mounted device other than an eyewear-type device

4.2. Example 2: Example of control following a detection result of slippage

5. Hardware configuration

### 6. Conclusion

### 1. Example of External Appearance of Head Mounted Device

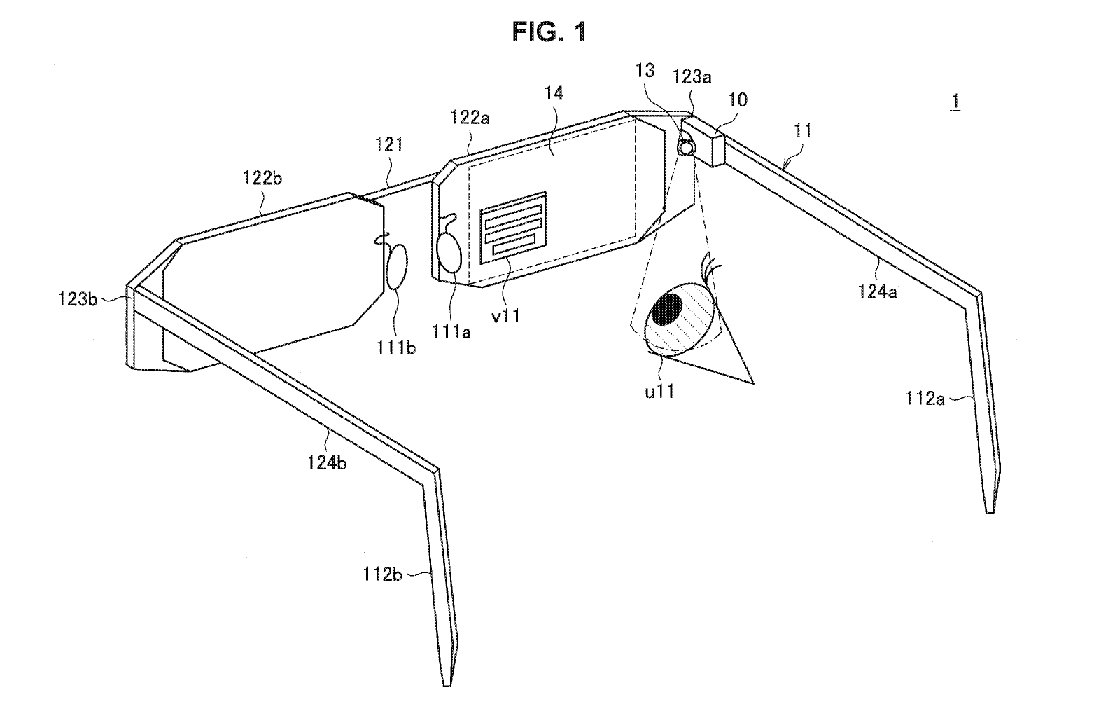

First, the general configuration of a head mounted device will be described with reference to FIG. 1. FIG. 1 is an explanatory view for explaining an example of the general configuration of a head mounted device, which illustrates an example of a case where the head mounted device is configured as a so-called eyewear-type (glasses-type) device.

In the example illustrated in FIG. 1, the head mounted device 1 is configured as an eyewear-type information processing apparatus in which a portion of a lens is formed as a transmissive display. Also, the head mounted device 1 illustrated in FIG. 1 has an imaging unit 13, and is configured to be able to recognize a user, on the basis of iris authentication technology, using an image of an eye u11 of the user captured by the imaging unit 13 as input information.

More specifically, as illustrated in FIG. 1, for example, the head mounted device 1 includes an information processing unit 10, the imaging unit 13, and a holding portion 11 that corresponds to a glasses frame. Also, with the head mounted device 1, at least one of the portions corresponding to the left and right lenses of the glasses is configured as a display unit 14 such as a so-called transmissive display. The head mounted device 1 presents information of which a user is to be notified on the display unit 14 as display information v11, for example, on the basis of this configuration.

Also, the holding portion 11 can include nose pads 111a and 111b, rims 122a and 122b, temple tips 112a and 112b, a bridge 121, and temples 124a and 124b, for example. Note that one end portion of the temple 124a is connected by a so-called hinge (a hinge mechanism or a link mechanism) to an end portion (end piece) of the rim 122a so as to be able to open and close (i.e., such that one is able to rotate with respect to the other). Note that in the description below, a portion that connects the end portion (end piece) of the rim 122a to one end portion of the temple 124a (i.e., a portion corresponding to the end piece and the hinge) may be referred to as “connecting portion 123a”. Similarly, one end portion of the temple 124b is connected by a so-called hinge to an end portion (end piece) of the rim 122b so as to be able to open and close. Note that in the description below, a portion that connects the end portion (end piece) of the rim 122b to one end portion of the temple 124b (i.e., a portion corresponding to the end piece and the hinge) may be referred to as “connecting portion 123b”.

In the example illustrated in FIG. 1, the holding portion 11 holds the display unit 14 (in other words, the portion corresponding to the lens) such that the display unit 14 is positioned in front of the eye u11 of the user (i.e., such that the display unit 14 and the eye u11 have a predetermined positional relationship), in a case where the head mounted device 1 is being worn. Also, in the example illustrated in FIG. 1, the holding portion 11 holds the imaging unit 13 such that the eye u11 is positioned within the imaging range of the imaging unit 13 (i.e., such that the imaging unit 13 and the eye u11 have a predetermined positional relationship), in a case where the head mounted device 1 is being worn.

More specifically, when the head mounted device 1 illustrated in FIG. 1 is worn on the head of the user, the nose pads 111a and 111b abut against the nose of the user so as to sandwich the nose from both sides. Also, the temple tips 112a and 112b positioned on tip ends of the temples 124a and 124b, respectively, abut against the ears of the user. As a result, the entire head mounted device 1 is held in a predetermined position with respect to the head of the user.

Also, the display unit 14, the imaging unit 13, and the information processing unit 10 are held in predetermined positions by the holding portion 11. More specifically, in the example illustrated in FIG. 1, a portion corresponding to the lens is fixed to the rims 122a and 122b of the holding portion 11, and at least one of the left and right lenses is configured as the display unit 14 (e.g., a transmissive display).

Also, the imaging unit 13 and the information processing unit 10 are held by the temple 124a of the holding portion 11. At this time, the imaging unit 13 is held in a position (e.g., in front of the eye u11) in which the eye u11 of the user can be captured, when the head mounted device 1 is being worn on the head of the user. Note that the position in which the imaging unit 13 is held is not limited as long as the imaging unit 13 is able to capture an image of the eye u11 of the user. As a specific example, the holding position of the imaging unit 13 may be adjusted by interposing an optical system such as a mirror between the imaging unit 13 and the eye u11. Of course, it goes without saying that the position in which the information processing unit 10 is held is also not particularly limited.

With the above configuration, when the head mounted device 1 is worn on the head of the user, a predetermined device (e.g., the display unit 14 and the imaging unit 13) are held in predetermined relative positions with respect to the head of the user.

The information processing unit 10 is a component for executing various processes to realize functions provided by the head mounted device 1. For example, the information processing unit 10 presents information of which the user is to be notified on the display unit 14 as display information v11, by controlling the operation of the display unit 14.

Also, at this time, the information processing unit 10 may control the display position of the display information v11 such that the display information v11 is superimposed on a real object (such as a building or a person, for example) that is in front of the eyes of the user, in a case where the user looks forward through the display unit 14 (i.e., the transmissive display), on the basis of so-called augmented reality (AR) technology.

In this case, for example, the information processing unit 10 causes an imaging unit such as a camera to capture an image in front of the eyes of the user, and recognizes a real object captured in the image by analyzing the captured image. Next, the information processing unit 10 calculates the position of the real object seen by the user, on a display surface on which the display unit 14 displays the display information, on the basis of the positional relationships among the imaging unit, the display unit 14, and the eye u11 of the user. Then, the information processing unit 10 displays the display information v11 related to the real object that was recognized, in the calculated position on the display surface. As a result, the information processing unit 10 enables the user to feel as though the display information v11 related to the real object seen by the user through the display unit 14 is superimposed on the real object.

Also, as another example, the information processing unit 10 may cause the imaging unit 13 to capture an image of the eye u11 of the user to perform iris authentication, by controlling the operation of the imaging unit 13. In this case, the information processing unit 10 may extract the iris from the image of the eye u11 captured by the imaging unit 13, and execute a process related to user authentication (i.e., a process based on iris authentication technology), on the basis of the pattern of the extracted iris.

Heretofore, the general configuration of a head mounted device has been described with reference to FIG. 1.

On the other hand, the head mounted device 1 is not always worn in an assumed wearing state. There are also cases where the head mounted device 1 is worn on the head in a state that deviates from the assumed wearing state, as with so-called slippage of glasses. Note that in the description below, states in which the wearing state of the head mounted device 1 deviates from the assumed wearing state may be collectively referred to as “slippage” or a “state in which slippage has occurred”. Note that in the description below, a state in which the head mounted device 1 is worn in the assumed wearing state, which is a state in which slippage is not occurring, may be referred to as a “reference state”.

In a state in which slippage has occurred in this way, a predetermined device such as the display unit 14 or the imaging unit 13 may not always be held so as to have a predetermined positional relationship with respect to a predetermined part such as an eye, and consequently, it may be difficult for the head mounted device 1 to correctly execute a function that uses the predetermined device.

As a specific example, in a state in which slippage has occurred, the relative positional relationship of the eye u11 with respect to the display unit 14 may differ from the relative positional relationship in the reference state. Therefore, even if the information processing unit 10 controls the display position of the display information v11 such that the display information v11 is superimposed on a real object that has been recognized, on the basis of AR technology, for example, the user may not feel as though the display information v11 is superimposed on the real object.

Also, as another example, in a state in which slippage has occurred, the relative positional relationship of the eye u11 with respect to the imaging unit 13 that captures an image of the eye u11 of the user may differ from the relative positional relationship in the reference state. Therefore, even if the information processing unit 10 tries to authenticate the user on the basis of iris authentication technology, using the image captured by the imaging unit 13 as input information, the image of the eye u11 may not be captured in a suitable state, and the authentication process may take time, and consequently authentication may fail.

Under such circumstances, for example, it may happen that while the user continues to wait for the completion of user authentication without noticing that slippage is occurring, information for authentication is unable to be acquired on the head mounted device 1 side, so the process related to acquiring the information is repeated, and consequently authentication fails.

With respect to such a problem, it is conceivable to prevent so-called slippage from occurring by securely fixing the head mounted device 1 to the head, but doing so may make it more difficult to get the head mounted device 1 on and off, and may reduce the comfort when the head mounted device 1 is worn.

Regarding this, the head mounted device 1 according to an embodiment of the present disclosure detects slippage when slippage occurs, and urges the user to correct the slippage (i.e., urges the user to wear the head mounted device 1 properly) by notifying the user of the detection result.

More specifically, the head mounted device 1 according to the embodiment is provided with a sensing unit (e.g., a force sensor such as a pressure sensor) in a position abutting against at least a part of the head of the user, such as in the nose pads 111a and 111b or the temple tips 112a and 112b of the holding portion 11. This sensing unit is designed to sense pressure between the sensing unit and the at least one part of the head of the user.

If the pressure sensed by each sensing unit differs from the pressure sensed by each sensing unit in a normal state, the information processing unit 10 of the head mounted device 1 determines that slippage is occurring, on the basis of such a configuration. Also, if the information processing unit 10 determines that slippage is occurring, the information processing unit 10 urges the user to correct the slippage, by controlling the operation of the display unit 14 to notify the user that slippage is occurring.

Also, the information processing unit 10 may inhibit the execution of some functions if it is determined that slippage is occurring. More specifically, if slippage is occurring, the information processing unit 10 may inhibit the execution of processes related to iris authentication, and the execution of processes related to the capturing of an image (i.e., the image of the eye u11) for this iris authentication. Also, as another example, the information processing unit 10 may temporarily stop displaying information based on AR technology if slippage is occurring.

Note that in the description below, a sensing unit for sensing a change in the state for the information processing unit 10 to determine whether slippage is occurring (for example, pressure between the sensing unit and at least a part of the head of the user) may be referred to as a “first sensing unit”. Also, the type of the first sensing unit is not necessarily limited to a force sensor such as a pressure sensor, as long as the information processing unit 10 is able to sense a change in the state in which the information processing unit 10 can detect whether slippage is occurring. As a specific example, the head mounted device 1 may be configured to determine whether slippage is occurring, by sensing a change in a state different from the pressure, such as brightness (illuminance), humidity, or temperature. Also, as another example, the head mounted device 1 may be configured to determine whether slippage is occurring, by having an optical sensor or an imaging unit or the like, and sensing a deviation in the wearing state (e.g., deviation in the wearing position) with respect to the reference state.

Also, the head mounted device 1 according to the embodiment may have a sensing unit (such as an electrostatic sensor, for example) provided at a portion of the holding portion 11 that the user touches to hold the head mounted device 1. The sensing unit is designed to sense this touch. Note that the rims 122a and 122b, the bridge 121, the connecting portions 123a and 123b, and the temples 124a and 124b, for example, are portions that the user touches to hold the head mounted device 1. Note that hereinafter, the sensing unit for sensing the user touching the holding portion 11 may be referred to as a “second sensing unit” to distinguish this sensing unit from the first sensing unit described above.

On the basis of such a configuration, the information processing unit 10 of the head mounted device 1 recognizes that the user is holding the head mounted device 1 to correct slippage, in a case where the sensing unit senses the user touching the holding portion 11 after slippage is sensed, for example. In this case, the information processing unit 10 may again determine whether slippage is occurring, on the basis of the detection results by the sensing unit provided in the nose pads 111a and 111b and the temple tips 112a and 112b, for example.

Note that the type of the second sensing unit is, needless to say, not necessarily limited to a sensor for sensing touch, such as an electrostatic sensor, as long as the information processing unit 10 is able to recognize that the user is holding the head mounted device 1 to correct slippage.

With the above configuration, according to the head mounted device 1 according to the embodiment, the user is able to wear the head mounted device 1 with a feeling similar the feeling of wearing normal glasses (i.e., is able to wear the head mounted device 1 without loss of comfort), without following a complicated procedure.

Also, even in a case where it is difficult for the head mounted device 1 to execute some functions due to slippage occurring, the user is able to recognize that slippage is occurring, by notification information presented by the head mounted device 1. As a result, the user is able to use the head mounted device 1 in a more preferred manner by correcting the slippage, on the basis of notification information presented by the head mounted device 1.

In particular, if there is slippage that the user does not notice, the head mounted device 1 may have difficulty properly acquiring information to be detected, and consequently, it may become difficult to execute functions that are based on this information. Even under such circumstances, according to the head mounted device 1 according to the embodiment, the user is able to recognize that slippage is occurring (and consequently, that some functions have become difficult to execute due to the slippage), on the basis of the notification information presented by the head mounted device 1.

Heretofore, the general configuration of the head mounted device 1 according to the embodiment has been described with reference to FIG. 1.

### 2. Functional Configuration

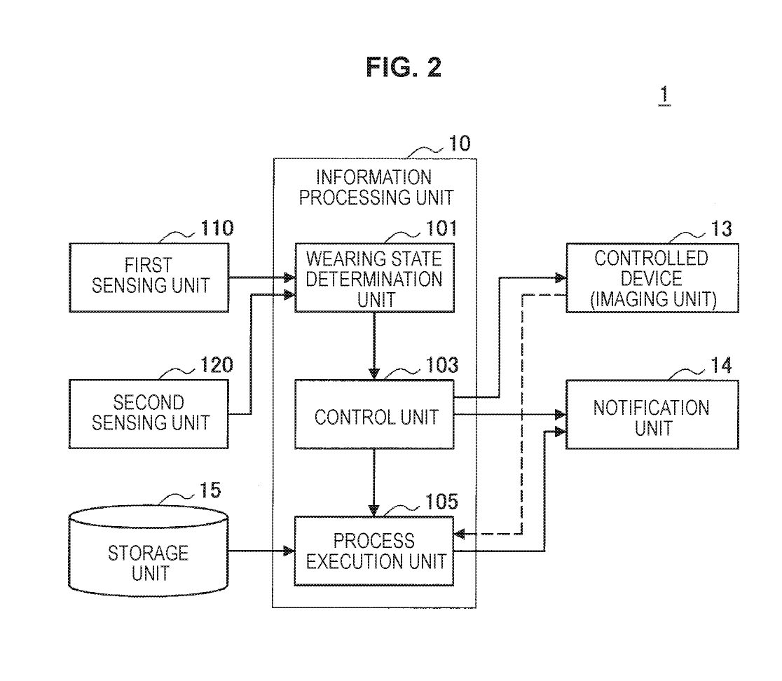

Next, an example of the functional configuration of the head mounted device 1 according to the embodiment, with particular focus on the operation relating to the detection of slippage, will be described with reference to FIG. 2. FIG. 2 is block diagram of an example of the functional configuration of the head mounted device 1 according to the embodiment.

As illustrated in FIG. 2, the head mounted device 1 according to the embodiment includes the information processing unit 10, a first sensing unit 110, a second sensing unit 120, a controlled device 13, a notification unit 14, and a storage unit 15. Also, the information processing unit 10 includes a wearing state determination unit 101, a control unit 103, and a process execution unit 105.

The first sensing unit 110 corresponds to the first sensing unit described above on the basis of FIG. 1, and senses a change in the state, for the information processing unit 10 to determine whether slippage is occurring. As a specific example, the first sensing unit 110 can include a sensor that is provided in a position abutting against at least a part of the head of the user, such as in the nose pads 111a and 111b or the temple tips 112a and 112b illustrated in FIG. 1, and that senses pressure between the sensor and the at least one part of the head of the user.

The first sensing unit 110 outputs the sensing result of a change in the state to be sensed, to the information processing unit 10.

The second sensing unit 120 corresponds to the second sensing unit described above on the basis of FIG. 1, and senses a change in the state, for the information processing unit 10 to recognize that the user is holding the head mounted device 1 to correct slippage. As a specific example, the second sensing unit 120 can include a sensor that is provided in a portion that the user touches to hold the head mounted device 1, such as the rims 122a and 122b, the bridge 121, the connecting portions 123a and 123b, and the temples 124a and 124b illustrated in FIG. 1, and that senses this touch.

The second sensing unit 120 outputs the sensing result of a change in the state to be sensed, to the information processing unit 10.

Note that the operation for the first sensing unit 110 to sense a change in the state to be sensed needless to say differs in accordance with the devices (such as various sensors and an imaging unit, for example) that make up the first sensing unit 110. As a specific example, if there is a change in the state to be sensed (e.g., the pressure), the first sensing unit 110 may be driven to sense this change, and output the sensing result to the information processing unit 10.

Also, as another example, the first sensing unit 110 may sequentially monitor the state to be sensed, and output the sensing result to the information processing unit 10 if a change in this state is sensed. Also, as another example, the first sensing unit 110 may sequentially monitor the state to be sensed, and output the monitoring result itself to the information processing unit 10. In this case, the information processing unit 10 need only recognize a change in the state to be sensed, on the basis of the monitoring result output from the first sensing unit 110. Note that similarly with the second sensing unit 120 as well, the operation for the second sensing unit 120 to sense a change in the state to be sensed needless to say differs in accordance with the devices that make up the second sensing unit 120.

The controlled device 13 represents a device to be controlled by the information processing unit 10. In the case of the example illustrated in FIG. 1, the imaging unit 13 can correspond to the controlled device 13. For example, the controlled device 13 may be controlled such that operation is temporarily stopped (in other words, operation is inhibited), or such that stopped operation is resumed, on the basis of control by the information processing unit 10.

Also, the controlled device 13 may be configured to be able to acquire various kinds of information, and may output the acquired information to the information processing unit 10.

As a specific example, a case in which the controlled device 13 is configured as an imaging unit that captures an image of the eye u11 of the user, as information for authenticating the user on the basis of iris authentication technology, will be focused on. In this case, the controlled device 13 configured as an imaging unit may output the captured image of the eye u11 to the information processing unit 10. As a result, the information processing unit 10 is able to authenticate the user by extracting the iris from the image of the eye u11 acquired from the controlled device 13, and analyzing the pattern of the extracted iris on the basis of iris authentication technology.

The notification unit 14 is a component for notifying the user of various kinds of information. For example, the display unit 14 illustrated in FIG. 1 corresponds to one example of the notification unit 14. The notification unit 14 may issue the notification information on the basis of control by the information processing unit 10.

Note that as long as the display unit 14 is configured to be able to notify the user of information, the notification unit 14 is not necessarily limited to a so-called display such as the display unit 14 illustrated in FIG. 1, and the kind of information to be issued is also not necessarily limited to the display information. As a specific example, the notification unit 14 may include a device that outputs sound, such as a so-called speaker, and may output information to be issued as audio information. Also, as another example, the notification unit 14 may include a device that vibrates, such as a so-called vibrator, and may notify the user of information to be issued, by a vibration pattern. Also, as another example, the notification unit 14 may include a light-emitting device, such as a light emitting diode (LED), and may notify the user of information to be issued, by a light-emitting pattern such as lighting or blinking.

The storage unit 15 is a storage unit within which is stored data (for example, various kinds of control information and a library for executing applications) for the information processing unit 10 to execute various functions.

The wearing state determination unit 101 acquires the sensing result from the first sensing unit 110, and determines the wearing state of the head mounted device 1 on the basis of the acquired sensing result. Note that in this description, the first sensing unit 110 will be described as a pressure sensor that is provided in each of the nose pads 111a and 111b and the temple tips 112a and 112b, in the head mounted device 1 illustrated in FIG. 1, to facilitate better understanding of the operation of the wearing state determination unit 101.

The wearing state determination unit 101 acquires information indicative of the pressure sensing result from each of the first sensing units 110 (i.e., pressure sensors) provided in the nose pads 111a and 111b and the temple tips 112a and 112b. Note that in the description below, the first sensing units 110 provided in the nose pads 111a and 111b and the temple tips 112a and 112b may be collectively referred to as a “plurality of first sensing units 110”. The wearing state determination unit 101 determines the wearing state of the head mounted device 1 on the basis of the pressure sensing results acquired from each of the plurality of first sensing units 110.

As a specific example, the wearing state determination unit 101 determines that the head mounted device 1 is not being worn if none of the plurality of first sensing units 110 are sensing pressure on the basis of the acquired sensing results.

Also, the wearing state determination unit 101 determines that the head mounted device 1 is being worn if it is recognized that at least one of the plurality of first sensing units 110 is sensing pressure. Note that if the head mounted device 1 is being worn, the wearing state determination unit 101 determines whether slippage is occurring, in accordance with the pressure sensing results from each of the plurality of first sensing units 110.

As a specific example, the wearing state determination unit 101 may recognize that the head mounted device 1 is being worn tilted either left or right, if a difference in the pressure sensing results between the nose pads 111a and 111b, and between the temple tips 112a and 112b, exceeds a threshold value. That is, in this case, the wearing state determination unit 101 may determine that slippage is occurring.

Similarly, the wearing state determination unit 101 may recognize that the head mounted device 1 is being worn tilted to either forward or backward, if a difference in the pressure sensing results between the nose pads 111a and 111b, and the temple tips 112a and 112b, exceeds a threshold value. That is, in this case, the wearing state determination unit 101 may determine that slippage is occurring.

Also, as another example, the wearing state determination unit 101 may determine whether slippage is occurring, in accordance with the ratio of the pressure sensing results from each of the plurality of first sensing units 110.

Also, as another example, the wearing state determination unit 101 may acquire a sensing result of pressure in the reference state acquired beforehand as reference data, and determine whether slippage is occurring by comparing the sensing results of each of the plurality of first sensing units 110 to this reference data. More specifically, the wearing state determination unit 101 may recognize that slippage is occurring if the difference between the reference data and the sensing results of each of the plurality of first sensing units 110 exceeds a threshold value.

Note that the ideal wearing state of the head mounted device 1 (i.e., the wearing state that can be the reference state) may be different for each user, in accordance with the physical characteristics of the user, for example. Therefore, the wearing state determination unit 101 may record reference data for determining slippage for each user.

In this case, for example, the head mounted device 1 may have a function for calibrating the wearing position. More specifically, for example, if the user is wearing the head mounted device 1 and user authentication is performed on the basis of iris authentication technology, the wearing state when this authentication is successful may be able to be recorded as the reference state. In this case, the wearing state determination unit 101 may acquire sensing results from each of the plurality of first sensing units 110 in a case in which there is a command to record the reference state, and reference data may be generated on the basis of the acquired sensing results.

Note that the trigger that causes the wearing state determination unit 101 to determine the wearing state of the head mounted device 1 is not particularly limited. As a specific example, the wearing state determination unit 101 may execute a process related to determining the wearing state in a case where a sensing result is output from at least one of the plurality of first sensing units 110.

Also, as another example, the wearing state determination unit 101 may monitor the sensing results output from each of the plurality of first sensing units 110 at predetermined timings, and execute a process related to determining the wearing state in accordance with the monitoring results.

Also, as another example, the wearing state determination unit 101 may execute a process related to determining the wearing state, on the basis of a sensing result of an operation by the user with respect to the head mounted device 1, as in a case where the user holds the head mounted device 1 to correct slippage or the like. As a specific example, the wearing state determination unit 101 may acquire the sensing result of touch with respect to the holding portion 11 of the head mounted device 1 from the second sensing unit 120, and recognize an operation by the user with respect to the head mounted device 1 (i.e., that the user is holding the head mounted device 1 to correct slippage) on the basis of the acquired sensing result.

As described above, the wearing state determination unit 101 determines the wearing state of the head mounted device 1 and outputs information indicative of the determination result to the control unit 103. Note that the wearing state determination unit 101 corresponds to one example of the “detection unit”.

The control unit 103 acquires information indicative of the determination result of the wearing state of the head mounted device 1 from the wearing state determination unit 101. The control unit 103 recognizes the wearing state of the head mounted device 1 on the basis of the acquired information, and executes various processes in accordance with the recognition result.

For example, if it is recognized that slippage is occurring, the control unit 103 controls the operation of the notification unit 14 to issue notification information for informing the user that slippage is occurring. At this time, the control unit 103 may cause the notification unit 14 to notify the user of information urging the user to correct the slippage, as notification information. Also, the control unit 103 may recognize the direction of slippage and deviation amount in accordance with the recognition result of the wearing state, and cause the notification unit 14 to issue information indicative of the recognized direction of slippage and deviation amount, as notification information. As a specific example, the control unit 103 may control the notification unit 14 configured as a display, such that the color of predetermined display information (i.e., notification information) changes in steps in accordance with the recognized deviation amount. Also, as another example, the control unit 103 may control the notification unit 14 configured as a vibrating device, such that the intensity of vibration changes in steps in accordance with the recognized deviation amount.

Also, the control unit 103 may control the operation of the controlled device 13, and the operation of the process execution unit 105, described later, in a case where it is recognized that slippage is occurring.

For example, an example of a case where the control unit 103 controls various operations related to iris authentication will be described. More specifically, the control unit 103 may cause an imaging unit (i.e., the controlled device 13) that captures of image of the eye u11 to stop operation related to image capture, in a case where it is recognized that slippage is occurring. Also, at this time, the control unit 103 may direct the process execution unit 105 to stop operation related to user authentication based on iris authentication technology.

Also, as another example, there are cases where it becomes difficult for the user to feel as though information is superimposed on a real object in front of the eyes of the user, when slippage occurs in a situation where the head mounted device 1 is performing display control based on AR technology. Therefore, in a situation where display control based on AR technology is being performed, the control unit 103 may direct the process execution unit 105 to stop display control based on the AR technology, for example, if it is recognized that slippage is occurring.

In this way, the control unit 103 may inhibit the execution of a predetermined function if it is recognized that slippage is occurring. Note that the control unit 103 may resume execution of the stopped (inhibited) function if it is recognized that slippage has been resolved.

Also, as another example, the control unit 103 may control the operation of the controlled device 13 such that the controlled device 13 can continue to operate, in a case where it is recognized that slippage is occurring.

As a specific example, an example of a case where the control unit 103 controls various operations related to iris authentication will be described. Let us assume, for example, that the relative position of an imaging unit that is the controlled device 13 with respect to the eye u11 of the user is off due to slippage occurring, and as a result, it is difficult for the imaging unit to capture an image of the eye u11.

At this time, the control unit 103 may recognize the relative position of the imaging unit (the controlled device 13) with respect to the eye u11, on the basis of the sensing results of each of the plurality of first sensing units 110, and control the direction in which, and the angle of view at which, the imaging unit captures an image, in accordance with the recognition result. As a more specific example, the control unit 103 need only calculate the direction in which the head mounted device 1 has deviated and the deviation amount, on the basis of the amount of pressure sensed by each of the plurality of first sensing units 110, and calculate a control direction and control amount of the direction in which, and the angle of view at which, the imaging unit captures an image, in accordance with the calculation result.

Such control enables the imaging unit (the controlled device 13) to capture an image of the eye u11, and thus enables the head mounted device 1 to continue various operations related to iris authentication.

The process execution unit 105 is a component for executing various functions. The process execution unit 105 receives a user operation via a predetermined operation unit (not shown in the drawings), identifies a function indicated by the operation content, and reads out data for executing the identified function (for example, control information and a library for executing an application) from the storage unit 15. Also, at this time, the process execution unit 105 may acquire information (such as setting information, for example) for executing the identified function, from the controlled device 13. Also, the process execution unit 105 executes the identified function on the basis of the data read out from the storage unit 15.

Also, as another example, the process execution unit 105 may execute a predetermined function on the basis of the sensing result from a predetermined sensing unit. As a more specific example, the process execution unit 105 may receive a sensing result indicating that the head mounted device 1 is being worn on the head of a user, and execute a function (e.g., the iris authentication function) for authenticating the user.

Note that the process execution unit 105 may cause the notification unit 14 to issue information indicative of the execution results of various functions.

Also, the process execution unit 105 may control the execution of various functions on the basis of a command from the control unit 103. As a specific example, the process execution unit 105 may stop execution of a function specified by the control unit 103. Also, the process execution unit 105 may resume execution of the stopped function on the basis of a command from the control unit 103.

Note that the functional configuration of the head mounted device 1 described above with reference to FIG. 2 is only an example. The configuration is not necessarily limited to the configuration described above as long as the operation of various components can be realized. As a specific example, at least some of the components of the head mounted device 1 may be provided in an external device that is different from the head mounted device 1, as with an information processing device such as a smartphone or the like, for example.

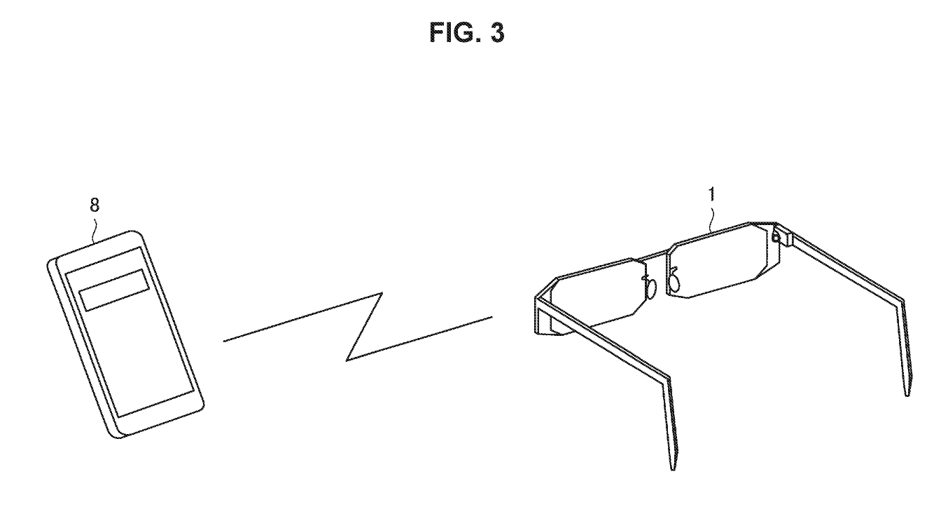

For example, FIG. 3 is an explanatory view for explaining an example of a way of using the head mounted device 1 according to the embodiment, and illustrates an example of a case where the head mounted device 1 and an information processing device 8 such as a smartphone are linked via communication. With the configuration illustrated in FIG. 3, a component corresponding to the information processing unit 10, among the components of the head mounted device 1 illustrated in FIG. 2, for example, may be provided on the information processing device 8 side. Also, with the configuration illustrated in FIG. 3, the head mounted device 1 may use an output unit (such as a display, for example) of the information processing device 8 as a component (i.e., the notification unit 14) for issuing notification information.

Also, as another example, at least some of the components of the head mounted device 1 illustrated in FIG. 2 may be provided in a server or the like that is connected to the head mounted device 1 via a network.

Heretofore, an example of the functional configuration of the head mounted device 1 according to the embodiment, with particular focus on the operation relating to the detection of slippage, has been described with reference to FIG. 2.

### 3. Processes

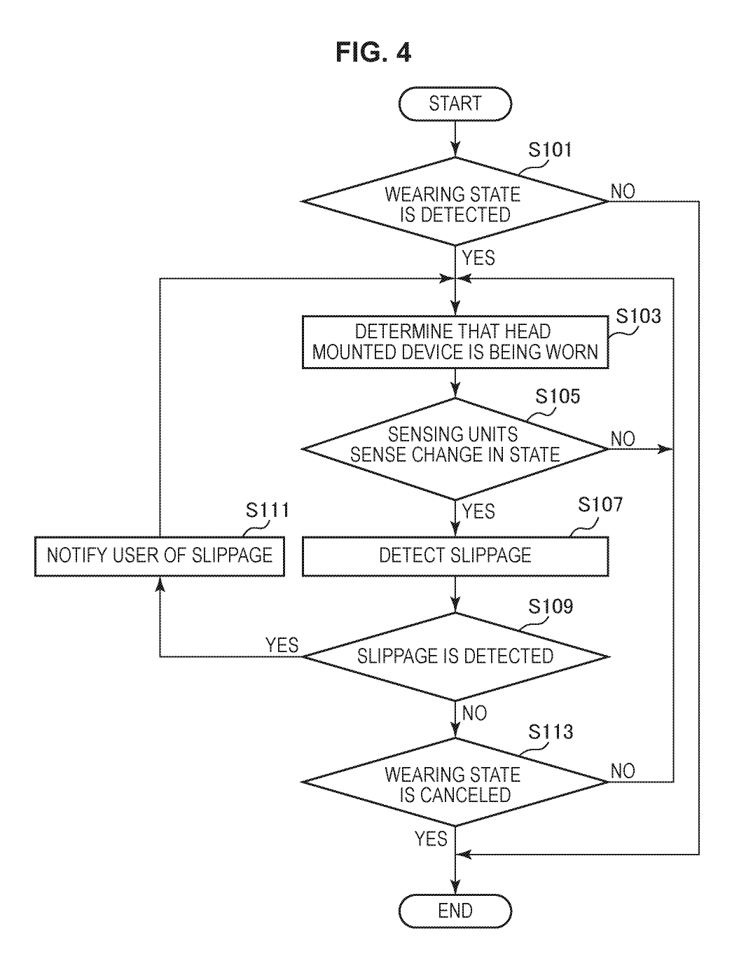

Next, an example of the flow of a series of processes in the head mounted device 1 according to the embodiment, with particular focus on the operation relating to the detection of slippage, will be described with reference to FIG. 4. FIG. 4 is a flowchart illustrating an example of the flow of a series of processes in the head mounted device 1 according to the embodiment.

### (Step S101)

The wearing state determination unit 101 of the information processing unit 10 acquires information indicative of the pressure sensing results from each of the first sensing units 110 (pressure sensors) provided in the nose pads 111a and 111b and the temple tips 112a and 112b.

Note that if none of the plurality of first sensing units 110 are sensing pressure (NO in step S101), the wearing state determination unit 101 determines that the head mounted device 1 is not being worn, and this series of processes ends.

### (Step S103)

Also, if it is recognized that at least one of the plurality of first sensing units 110 is sensing pressure (YES in step S101), the wearing state determination unit 101 determines that the head mounted device 1 is being worn.

### (Step S105)

Note that if the head mounted device 1 is being worn, the wearing state determination unit 101 determines whether slippage is occurring, in accordance with the pressure sensing results from each of the plurality of first sensing units 110. Note that the wearing state determination unit 101 may recognize that there is no change in the wearing state as long as a sensing result is not output from the first sensing unit 110 (NO in step S105).

### (Step S107)

When the wearing state determination unit 101 acquires a pressure sensing result (in other words, a sensing result of a change in pressure) from at least one of the plurality of first sensing units 110, the wearing state determination unit 101 determines whether slippage is occurring, in accordance with the sensing result.

For example, the wearing state determination unit 101 may acquire a sensing result of pressure in the reference state acquired beforehand as reference data, and determine whether slippage is occurring by comparing the sensing results of each of the plurality of first sensing units 110 to this reference data. More specifically, the wearing state determination unit 101 may recognize that slippage is occurring if the difference between reference data and the sensing results of each of the plurality of first sensing units 110 exceeds a threshold value.

Therefore, if slippage is occurring, the wearing state determination unit 101 is able to detect this slippage.

As described above, the wearing state determination unit 101 determines the wearing state of the head mounted device 1 and outputs information indicative of the determination result to the control unit 103. The control unit 103 acquires information indicative of the determination result of the wearing state of the head mounted device 1 from the wearing state determination unit 101, and recognizes the wearing state of the head mounted device 1 on the basis of the acquired information.

### (Step S111)

If it is recognized that slippage is occurring (YES in step S109), the control unit 103 controls the operation of the notification unit 14 to issue notification information for informing the user that slippage is occurring. At this time, the control unit 103 may cause the notification unit 14 to notify the user of information urging the user to correct the slippage, as notification information.

### (Step S113)

The head mounted device 1 continues the series of processes of step S103 to S111 during the period throughout which the head mounted device 1 is being worn by the user (NO in step S113).

Also, if it is recognized that the state has shifted to a state in which none of the plurality of first sensing units 110 are sensing pressure, the wearing state determination unit 101 recognizes that the state in which the head mounted device 1 is being worn has been canceled (i.e., that the head mounted device 1 has been removed from the head of the user). If the state in which the head mounted device 1 is being worn has been canceled (YES in step S113), the head mounted device 1 ends the series of processes.

Heretofore, an example of the flow of a series of processes in the head mounted device 1 according to the embodiment, with particular focus on the operation relating to the detection of slippage, has been described with reference to FIG. 4.

### 4. Examples

Next, examples of the head mounted device 1 according to the embodiment will be described.

### 4.1. Example 1: Example of Application to a Head Mounted Device Other than an Eyewear-Type Device

In the embodiment described above, an example of an eyewear-type head mounted device 1 was described. On the other hand, a head mounted device to which control relating to the detection of a wearing state (in particular, the detection of slippage) by the head mounted device 1 according to the embodiment can be applied is not necessarily limited to an eyewear-type device. Therefore, another example of the head mounted device 1 to which the control relating to the detection of the wearing state described above can be applied will be described as Example 1.

### (HMD)

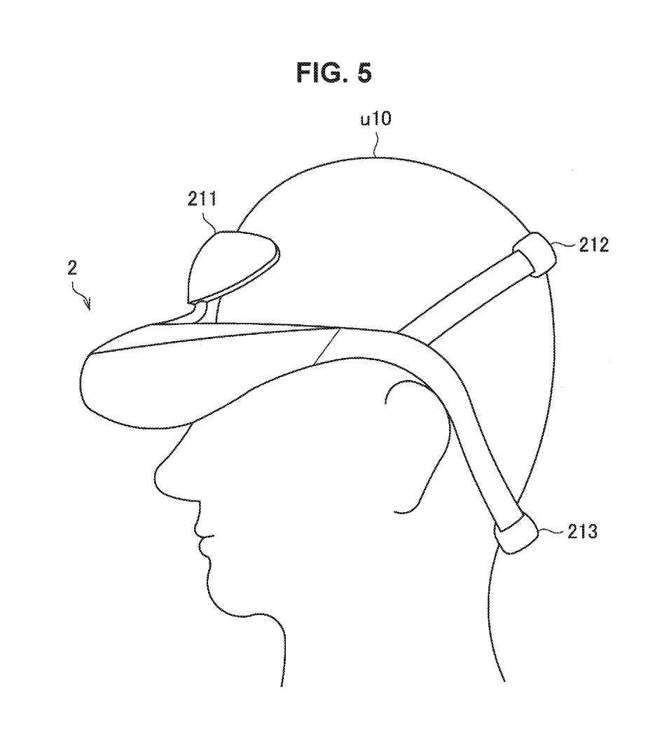

For example, FIG. 5 is an explanatory view for explaining an example of a head mounted device according to Example 1, which illustrates an example of a case where the head mounted device is configured as an HMD. Note that below, the head mounted device illustrated in FIG. 5 may be referred to as “head mounted device 2” to distinguish this head mounted device from the eyewear-type head mounted device 1 described above.

As illustrated in FIG. 5, the head mounted device 2 is held to the head of a user u10 by holding portions denoted by reference numerals 211, 212, and 213.

The holding portion 211 is provided so as to abut against the front of the head (the forehead) of the user u10 in a case where the head mounted device 2 is being worn on the head of the user u10. Also, the holding portion 212 is provided so as to abut against the upper part of the back of the head of the user u10 in a case where the head mounted device 2 is being worn on the head of the user u10. Also, the holding portion 213 is provided so as to abut against the lower part of the back of the head of the user u10 in a case where the head mounted device 2 is being worn on the head of the user u10.

In this way, the head mounted device 2 is held to the head of the user u10 at three points, i.e., by the holding portions 211, 212, and 213.

Therefore, the head mounted device 2 illustrated in FIG. 5 need only be provided with the first sensing units 110 described above at the holding portions 211, 212, and 213, and need only detect the wearing state (and thus slippage) with respect to the head of the user u10 on the basis of the sensing results of each of the first sensing units 110.

### (Goggles)

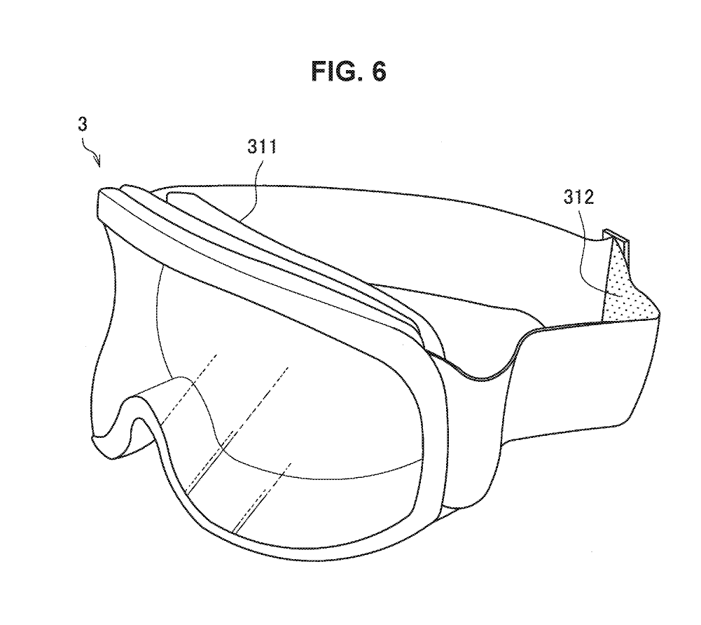

Also, FIG. 6 is an explanatory view for explaining another example of a head mounted device according to Example 1, which illustrates an example of a case where the head mounted device is configured as a goggle-type device. Note that below, the head mounted device illustrated in FIG. 6 may be referred to as “head mounted device 3” to distinguish this head mounted device from the other head mounted devices described above.

As illustrated in FIG. 6, the head mounted device 3 is held to the head of the user u10 by a holding portions denoted by reference numerals 311 and 312.

The holding portion 311 is provided so as to abut against the area around the eyes of the user u10 in a case where the head mounted device 3 is being worn on the head of the user u10. Also, the holding portion 312 is configured as a band-like member having elasticity, such as rubber, cloth, or resin, for example, and is configured such that at least a portion abuts against a part of the head of the user u10.

In this way, the head mounted device 3 is held to the head of the user u10 by the elastic force of the holding portion 312, by the holding portion 311 abutting against the area around the eyes of the user u10, and the holding portion 312 being wrapped around the head of the user u10.

Therefore, the head mounted device 3 illustrated in FIG. 6 need only be provided with the first sensing units 110 described above at the holding portions 311 and 312, for example, and need only detect the wearing state (and thus slippage) with respect to the head of the user u10 on the basis of the sensing results of each of the first sensing units 110.

### (Attachment Type)

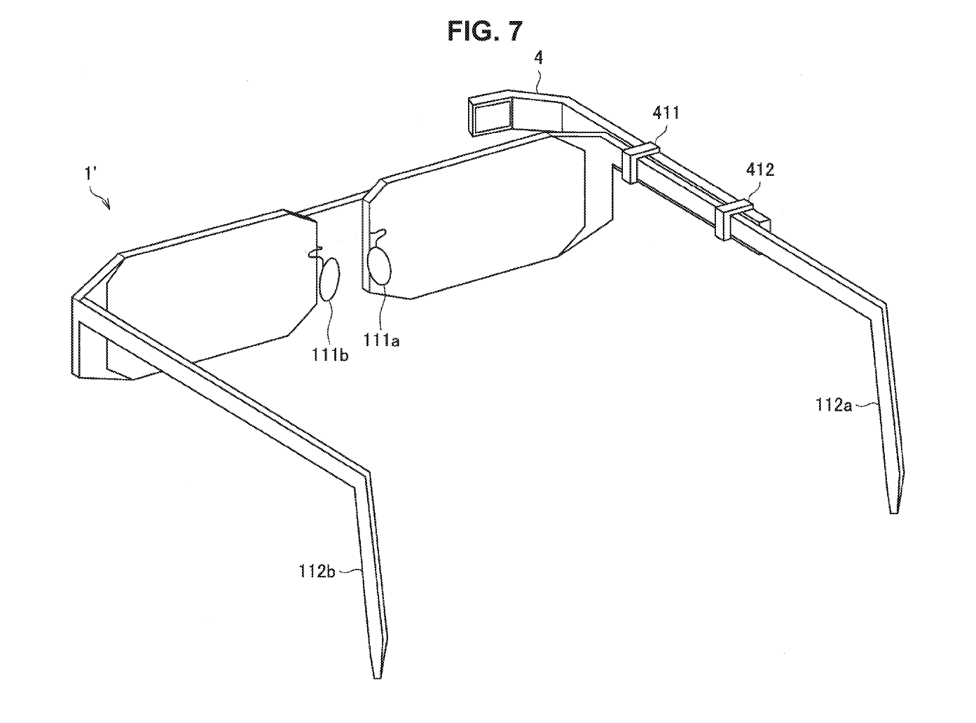

Also, FIG. 7 is an explanatory view for explaining another example of the head mounted device according to Example 1. FIG. 7 illustrates an example of a head mounted device that is configured as a so-called attachment, which is indirectly held in a predetermined relative position with respect to the head of the user u10, by being attached to a member (device) that is worn on the head, such as glasses. Note that below, the head mounted device illustrated in FIG. 7 may be referred to as “head mounted device 4” to distinguish this head mounted device from the other head mounted devices described above.

In the example illustrated in FIG. 7, the head mounted device 4 is configured to be able to be attached to an eyewear-type device 1′. More specifically, the head mounted device 4 includes holding portions 411 and 412, and is held in a predetermined position on the device 1′ by the holding portions 411 and 412.

Therefore, the head mounted device 4 illustrated in FIG. 7 may be provided with the first sensing units 110 described above at the holding portions 411 and 412, for example, and may detect the wearing state with respect to the head of the user u10 on the basis of the sensing results of each of the first sensing units 110. As a result, if the wearing position with respect to the eyewear-type device 1′ deviates from the predetermined wearing position, the head mounted device 4 is able to detect this deviation.

Also, the head mounted device 4 may be configured to be able to recognize slippage of the eyewear-type device 1′ by linking with the eyewear-type device 1′. More specifically, the first sensing units 110 described above need only be provided in the nose pads 111a and 111b and the temple tips 112a and 112b of the eyewear-type device 1′, and the head mounted device 4 need only acquire the detection results from the first sensing units 110. With such a configuration, the head mounted device 4 can detect whether slippage is occurring, by the wearing state of the eyewear-type device 1′ with respect to the head of the user u10, and the attaching state of the head mounted device 4 with respect to the eyewear-type device 1′.

Also, even if the head mounted device is configured as an eyewear-type device, the head mounted device may also be configured as a so-called monocular-type device in which a lens is provided on only one of the left or right sides, for example. In this case, the position where the first sensing unit 110 is provided need only be changed as appropriate, in accordance with the mode of the holding portion for holding the head mounted device to the head of the user u10.

As a specific example, the head mounted device may also be held at the top of the head of the user u10, as with so-called headphones. Also, as another example, the head mounted device may be held to an ear of the user u10 by hooking a hook-shaped holding portion around the ear of the user. Also, as another example, the head mounted device may be held to an ear of the user u10 by a holding portion configured to be able to be inserted into an earhole of the user u10.

Heretofore, other examples of the head mounted device according to the embodiment have been described with reference to FIGS. 5 to 7, as Example 1.

### 4.2. Example 2: Example of Control Following a Detection Result of Slippage

Next, an example of control following a detection result of slippage, in the head mounted device according to the embodiment, will be described as Example 2. Note that in this description, a case in which an imaging device capable of capturing an image is used worn on a head, by a member referred to as a so-called head mount kit (i.e., a member for holding the imaging device in a predetermined position with respect to the head) will be described as an example.

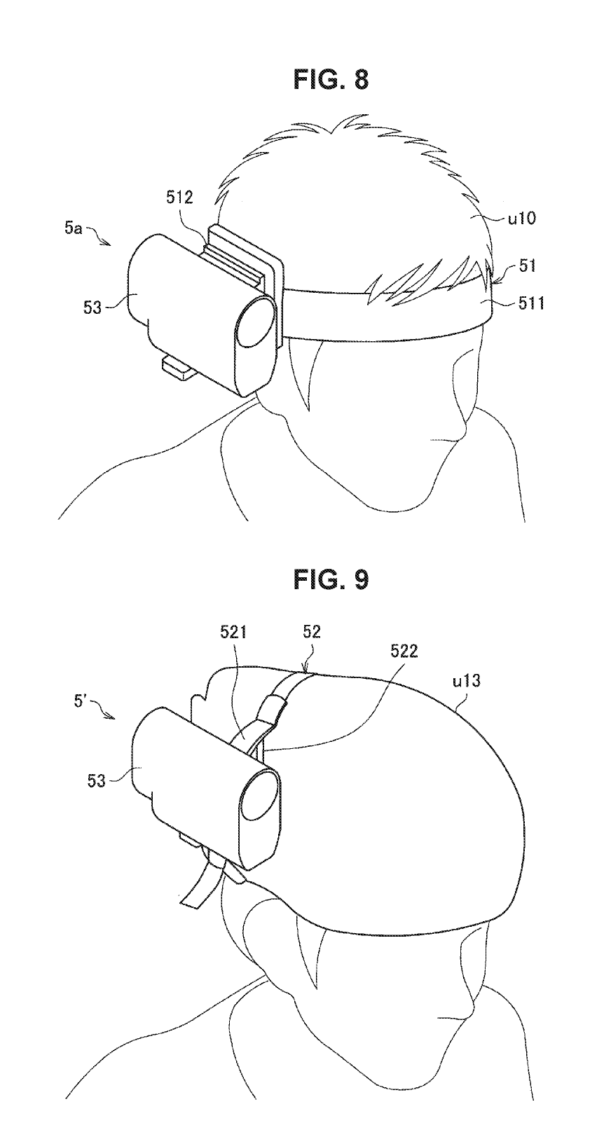

For example, FIG. 8 is an explanatory view for explaining an overview of a head mounted device according to Example 2. Note that the head mounted device illustrated in FIG. 8 may be referred to as “head mounted device 5” to distinguish this head mounted device from the other head mounted devices described above.

As illustrated in FIG. 8, the head mounted device 5 includes an imaging device 53 that captures an image, and a holding portion 51 that holds the imaging device 53 to the head of the user u10. Also, the holding portion 51 includes a band portion 511 and an attachment portion 512.

The band portion 511 is configured as a band-like member having elasticity, such as rubber, cloth, or resin, for example, and is configured such that at least a portion abuts against a part of the head of the user u10. The band portion 511 is attached to the head of the user u10 by the elastic force of the band portion 511, as a result of the band portion 511 being wrapped around the head of the user u10. Also, the attachment portion 512 is held to a portion of the band portion 511. That is, the attachment portion 512 is held in a predetermined relative position with respect to the head of the user u10, by the band portion 511 being attached to the head.

Also, at least a portion of the imaging device 53 is configured to be able to be attached to the attachment portion 512. Note that the configuration for attaching the imaging device 53 to the attachment portion 512 is not particularly limited. As a specific example, the imaging device 53 may be attached to the attachment portion 512 by fitting at least a portion of the imaging device 53 to the attachment portion 512. Also, as another example, the imaging device 53 may be attached to the attachment portion 512 grasping the imaging device 53 with at least one member of the attachment portion 512.

With such a configuration, the imaging device 53 is held in a predetermined relative position with respect to the attachment portion 512, and consequently, the imaging device 53 is held in a predetermined relative position with respect to the head of the user u10.

Also, the head mounted device 5 illustrated in FIG. 8 has the first sensing units 110 described above provided in the band portion 511 and the attachment portion 512. With such a configuration, the head mounted device 5 is able to detect the wearing state (and thus slippage) with respect to the head of the user u10 on the basis of the sensing results of each of the first sensing units 110. Note that the type of the first sensing units 110 is not particularly limited, just as described above, and it goes without saying that the various sensing units may be appropriately selected in accordance with the characteristics of the band portion 511 and the attachment portion 512.

Note that the example illustrated in FIG. 8 is only an example. The configuration of the head mounted device 5 is not necessarily limited as long as the head mounted device 5 is able to hold the imaging device 53 in a predetermined relative position with respect to the head of the user u10.

For example, FIG. 9 is an explanatory view for explaining another mode of the head mounted device according to Example 2. Note that the head mounted device illustrated in FIG. 9 may be referred to as “head mounted device 5′” to distinguish this head mounted device from the head mounted device illustrated in FIG. 8.

As illustrated in FIG. 9, the head mounted device 5′ is held in a predetermined relative position with respect to the head of the user u10 by being attached to a helmet u13 worn on the head of the user u10.

As illustrated in FIG. 9, the head mounted device 5′ includes an imaging device 53, and a holding portion 52 that holds the imaging device 53 to the helmet u13. Also, the holding portion 52 includes a band portion 521 and an attachment portion 522.

The band portion 521 is configured as a band-like member having elasticity, such as rubber, cloth, or resin, for example, and is attached to the helmet u13 by being wrapped around a portion of the helmet u13. Also, the attachment portion 522 is held to a portion of the band portion 521. That is, the attachment portion 522 is held in a predetermined relative position with respect to the helmet u13, and thus the attachment portion 522 is held in a predetermined relative position with respect to the head of the user u10, by the band portion 521 being attached to the helmet u13.

Also, at least a portion of the imaging device 53 is able to be attached to the attachment portion 522. Note that the configuration for attaching the imaging device 53 to the attachment portion 522 is not particularly limited, just like the attachment portion 512 described above with reference to FIG. 8.

With such a configuration, the imaging device 53 is held in a predetermined relative position with respect to the attachment portion 522, and consequently, the imaging device 53 is held in a predetermined relative position with respect to the head of the user u10.

Also, the head mounted device 5′ illustrated in FIG. 9 has the first sensing units 110 described above provided in the band portion 521 and the attachment portion 522. With such a configuration, the head mounted device 5′ is able to detect the attaching state with respect to the helmet u13, and thus is able to detect the wearing state (and thus slippage) with respect to the head of the user u10, on the basis of the sensing results of each of the first sensing units 110.

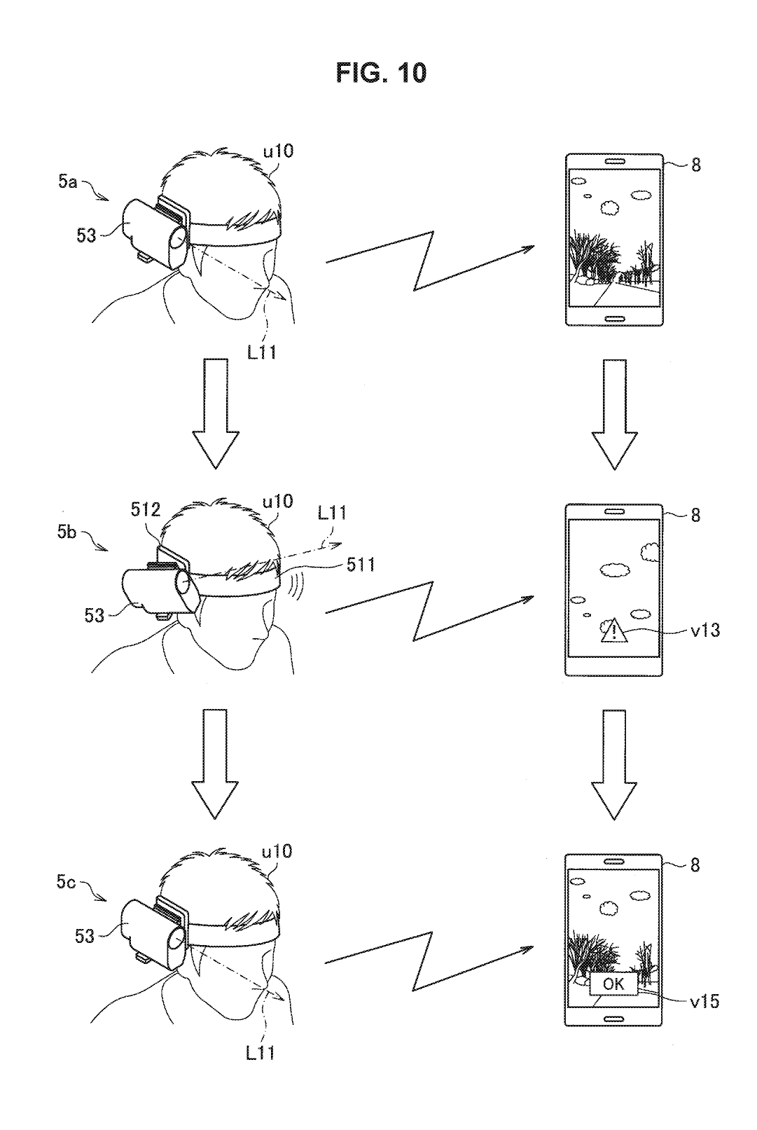

Next, an example of control following a detection result of slippage, by the head mounted device 5 in a case where the head mounted device 5 according to the example illustrated in FIG. 8 is used will be described with reference to FIG. 10. FIG. 10 is an explanatory view for explaining an example of control following a detection result of slippage, in the head mounted device according to Example 2.

In FIG. 10, reference character 5a denotes a state (i.e., a reference state) in which the head mounted device 5 is worn on the head of the user u10, and slippage is not occurring. Also, reference numeral L11 schematically denotes the direction in which the imaging device 53 captures an image.

In the example illustrated in FIG. 10, the head mounted device 5 is connected to the information processing device 8 via a network, and transmits an image captured by the imaging device 53 to the information processing device 8 over the network. Also, the information processing device 8 displays the image transmitted from the head mounted device 5 to a display portion such as a display. As a result, the user is able to confirm the image captured by the imaging device 53 (i.e., the image in the direction denoted by reference numeral L11) via the information processing device 8.

Next, the state denoted by reference numeral 5b will be focused on. The state denoted by reference numeral 5b illustrates one example of a case where slippage has occurred due to impact or vibration or the like, and the relative position of the imaging device 53 with respect to the head of the user u10 has changed (i.e., a case where the wearing state of the head mounted device 5 has changed).

In the state denoted by reference numeral 5b, the imaging device 53 is pointing in a different direction than the imaging device 53 is in the state denoted by reference numeral 5a as a result of slippage, making it difficult to capture an image in the direction assumed by the user u10.

At this time, the head mounted device 5 recognizes that slippage is occurring, in accordance with the sensing results of the first sensing units 110 provided in the band portion 511 and the attachment portion 512, and notifies the user that slippage is occurring, by issuing notification information. As a specific example, the head mounted device 5 may notify the user that slippage is occurring, by vibrating a vibrating portion such as a vibrator provided on a portion of the holding portion 51. Also, as another example, the head mounted device 5 may notify the user that slippage is occurring, by displaying predetermined display information v13 on a display portion of the information processing device 8 or the like.

Next, the state denoted by reference numeral 5c will be focused on. The state denoted by reference numeral 5c illustrates a state in which slippage has been resolved by the user reattaching the head mounted device 5.

More specifically, if the wearing state has changed on the basis of the sensing results from the first sensing units 110 after it has been determined that slippage is occurring, the head mounted device 5 again determines whether slippage is occurring. If at this time it is determined that slippage is not occurring, the head mounted device 5 is able to recognize that the slippage has been corrected by the user. In such as case, the head mounted device 5 may notify the user that slippage has been resolved, for example.

For example, in the example illustrated in FIG. 10, the head mounted device 5 notifies the user that slippage has been resolved, by displaying predetermined display information v15 on the display portion of the information processing device 8 or the like.

Heretofore, an example of control following a detection result of slippage, by the head mounted device according to the embodiment has been described with reference to FIGS. 8 to 10, as Example 2.

### 5. Hardware Configuration

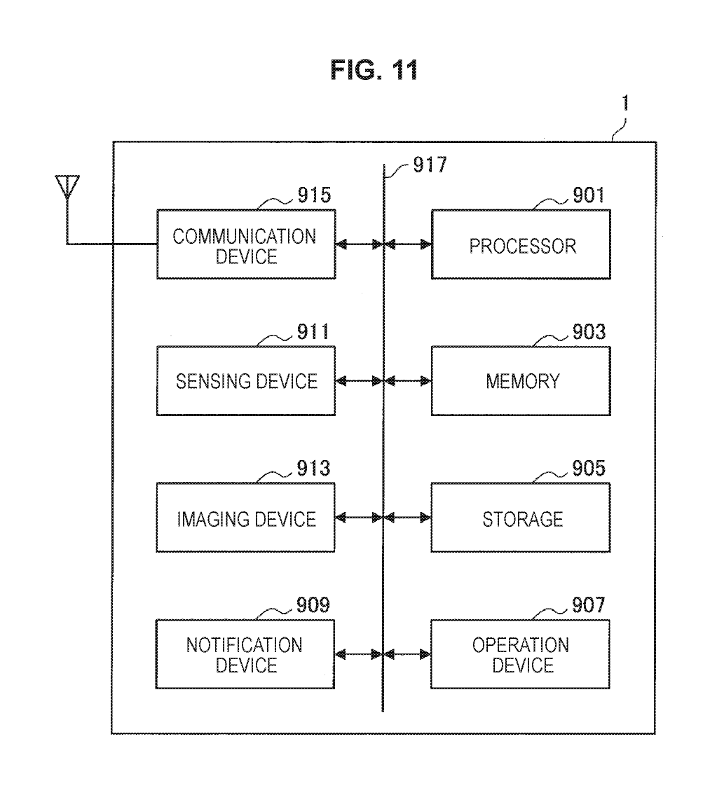

Next, an example of a hardware configuration of the head mounted device 1 according to an embodiment of the present disclosure will be described reference to FIG. 11. FIG. 11 is an example of a hardware configuration of the head mounted device 1 according to an embodiment of the present disclosure.

As illustrated in FIG. 11, the head mounted device 1 according to the embodiment includes a processor 901, memory 903, storage 905, an operation device 907, a notification device 909, a sensing device 911, an imaging device 913, and a bus 917. Also, the head mounted device 1 may include a communication device 915.

The processor 901 may be a central processing unit (CPU), a graphics processing unit (GPU), a digital signal processor (DSP), or a system on chip (SOC), for example, and executes various processes in the head mounted device 1. The processor 901 can be formed by an electronic circuit for executing various calculation processes, for example. Note that the wearing state determination unit 101, the control unit 103, and the process execution unit 105 described above can be realized by the processor 901.

The memory 903 includes random access memory (RAM) and read only memory (ROM), and stores data and programs to be executed by the processor 901. The storage 905 can include a storage medium such as semiconductor memory or a hard disk. For example, the storage unit 15 described above can be realized by at least one of the memory 903 and the storage 905, or by a combination of both.

The operation device 907 has a function of generating an input signal for the user to perform a desired operation. The operation device 907 can be configured as a touch panel, for example. Also, as another example, the operation device 907 may be formed by, for example, an input portion for the user to input information, such as a button, a switch, and a keyboard, and an input control circuit that generates an input signal on the basis of input by the user, and supplies the input signal to the processor 901, and the like.

The notification device 909 is one example of an output device, and may be a device such as a liquid crystal display (LCD) device or an organic light emitting diode (OLED) display. In this case, the notification device 909 can notify the user of predetermined information by displaying a screen.

Also, the notification device 909 may be a device that notifies the user of predetermined information by outputting a predetermined audio signal, such as a speaker.

Note that the example of the notification device 909 illustrated above is just an example. The mode of the notification device 909 is not particularly limited as long as the user is able to be notified of predetermined information. As a specific example, the notification device 909 may be a device that notifies the user of predetermined information by a lighting or blinking pattern. Note that the notification unit 14 described above can be realized by the notification device 909.

The imaging device 913 includes an imaging element that captures an object and obtains digital data of the captured image, such as a complementary metal-oxide semiconductor (CMOS) image sensor or a charge coupled device (CCD) image sensor. That is, the imaging device 913 has a function of capturing a still image or a moving image via an optical system such as a lens, in accordance with control of the processor 901. The imaging device 913 may store the captured image in the memory 903 and the storage 905. Note that if the controlled device 13 described above is an imaging unit, the imaging unit can be realized by the imaging device 913.

The sensing device 911 is a device for sensing various states. The sensing device 911 can be formed by a sensor for sensing various states, such as a pressure sensor, an illuminance sensor, or a humidity sensor. Also, the sensing device 911 may be formed by a sensor for sensing contact or proximity of a predetermined object, such as an electrostatic sensor. Also, the sensing device 911 may be formed by a sensor for detecting a change in the position and orientation of a predetermined case, such as an acceleration sensor or an angular velocity sensor. Also, the sensing device 911 may be formed by a sensor for sensing a predetermined object, such as a so-called optical sensor. Note that the first sensing unit 110 and the second sensing unit 120 described above can be realized by the sensing device 911.

The communication device 915 is communication means provided in the head mounted device 1, and communicates with an external device over a network. The communication device 915 is a wired or wireless communication interface. If the communication device 915 is configured as a wireless communication interface, the communication device 915 may include a communication antenna, a radio frequency (RF) circuit, and a baseband processor and the like.

The communication device 915 has a function of performing various kinds of signal processing on signals received from an external device, and can supply a digital signal generated from a received analog signal to the processor 901.

The bus 917 bilaterally connects the processor 901, the memory 903, the storage 905, the operation device 907, the notification device 909, the sensing device 911, the imaging device 913, and the communication device 915 together. The bus 917 may include a plurality of types of buses.

Also, a program for fulfilling functions similar to the functions of the configuration in which the head mounted device 1 described above has hardware such as a processor, memory, and storage built into a computer, can also be created. Also, a computer-readable storage medium on which this program is recorded can also be provided.

### 6. Summary

As described above, the head mounted device according to the embodiment is provided with a sensing unit (such as a pressure sensor, for example) for sensing information relating to a holding state, by a holding portion that holds a predetermined device such as an imaging unit or a display unit in a predetermined relative position with respect to the head of a user. On the basis of such a configuration, the head mounted device according to the embodiment determines the wearing state of the head mounted device with respect to the head of the user (in particular, whether slippage is occurring), on the basis of the sensing result by the sensing unit, and executes various processes in accordance with the determination result.

With such a configuration, if slippage occurs with the head mounted device such that it becomes difficult to execute some of the functions, for example, the head mounted device can notify the user that slippage is occurring, by presenting the user with predetermined information. As a result, the user is able to recognize that slippage is occurring, on the basis of notification information presented by the head mounted device, and can thus use the head mounted device in a more preferred manner by correcting the slippage.

In particular, if there is slippage that the user does not notice, the head mounted device may have difficulty properly acquiring information to be detected, and consequently, it may become difficult to execute functions that are based on this information. Even under such circumstances, according to the head mounted device according to the embodiment, the user is able to recognize that slippage is occurring (and consequently, that some functions have become difficult to execute due to the slippage), on the basis of the notification information presented by the head mounted device.

Also, with a configuration such as the configuration described above, the head mounted device according to the embodiment does not necessarily need a structure for firmly fixing the head mounted device itself to the head of the user. Therefore, the user is able to wear the head mounted device according to the embodiment with a feeling similar the feeling of wearing normal glasses (i.e., is able to wear the head mounted device without loss of comfort), without following a complicated procedure.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

an acquisition unit configured to acquire a sensing result from a sensing unit that senses information relating to a holding state of a predetermined device, by a holding portion for holding the device, directly or indirectly, with respect to at least a part of a head of a user; and

a detection unit configured to detect a deviation between the holding state of the device and a predetermined holding state set in advance, on the basis of the acquired sensing result.

(2)

The information processing apparatus according to (1),

in which the detection unit detects the deviation based on the sensing result in accordance with a change in pressure between the holding portion and at least a part of the head against which the holding portion abuts.

(3)

The information processing apparatus according to (1) or (2),

in which the detection unit detects the deviation on the basis of the sensing result of each of a plurality of the sensing units.

(4)

The information processing apparatus according to any one of (1) to (3),

in which at least a portion of the device held by the holding portion is a device that targets at least a part of the head of the user, and acquires information relating to the target, and

the detection unit detects a deviation in a relative positional relationship between the device and the target, as the deviation.

(5)

The information processing apparatus according to (4),

in which the device is an imaging unit that, with an eye of the user as an object, captures an image of the object.

(6)

The information processing apparatus according to any one of (1) to (5), including:

a control unit configured to execute predetermined control in accordance with a detection result of the deviation.

(7)

The information processing apparatus according to (6),

in which the control unit causes a predetermined output portion to issue notification information in accordance with the detection result of the deviation.

(8)

The information processing apparatus according to (6),

in which the control unit controls operation relating to a predetermined authentication, in accordance with the detection result of the deviation.

(9)

The information processing apparatus according to (6),

in which the control unit inhibits execution of a predetermined function, in accordance with the detection result of the deviation.

(10)

The information processing apparatus according to (6),

in which the control unit controls operation of the device, in accordance with the detection result of the deviation.

(11)

The information processing apparatus according to any one of (1) to (10),

in which the detection unit receives a sensing result from another sensing unit that is provided on the holding portion and is different from the sensing unit, and detects the deviation.

(12)

The information processing apparatus according to any one of (1) to (11), including:

the holding portion,

in which the holding portion holds a display portion as at least a portion of the device, in front of the user so as to block at least part of a field of view of the user.

(13)

The information processing apparatus according to any one of (1) to (12),

in which the sensing unit is provided on at least a portion of the holding portion.

(14)

The information processing apparatus according to any one of (1) to (13),

in which the holding portion holds the device to a wearing portion worn on at least a part of the head of the user.

(15)

The information processing apparatus according to any one of (1) to (14), including:

the sensing unit.

(16)

An information processing method including, by a processor:

acquiring a sensing result from a sensing unit that senses information relating to a holding state of a predetermined device, by a holding portion for holding the device, directly or indirectly, with respect to at least a part of a head of a user; and

detecting a deviation between the holding state of the device and a predetermined holding state set in advance, on the basis of the acquired sensing result.

(17)

A program causing a computer to execute:

acquiring a sensing result from a sensing unit that senses information relating to a holding state of a predetermined device, by a holding portion for holding the device, directly or indirectly, with respect to at least a part of a head of a user; and

detecting a deviation between the holding state of the device and a predetermined holding state set in advance, on the basis of the acquired sensing result.

### REFERENCE SIGNS LIST

1 head mounted device
10 information processing unit
101 wearing state determination unit
103 control unit
105 process execution unit
11 holding portion
13 controlled device
14 notification unit
15 storage unit
110 first sensing unit
120 second sensing unit

1. An information processing apparatus comprising:
an acquisition unit configured to acquire a sensing result from a sensing unit that senses information relating to a holding state of a predetermined device, by a holding portion for holding the device, directly or indirectly, with respect to at least a part of a head of a user; and
a detection unit configured to detect a deviation between the holding state of the device and a predetermined holding state set in advance, on the basis of the acquired sensing result.

2. The information processing apparatus according to claim 1,
wherein the detection unit detects the deviation based on the sensing result in accordance with a change in pressure between the holding portion and at least a part of the head against which the holding portion abuts.

3. The information processing apparatus according to claim 1,
wherein the detection unit detects the deviation on the basis of the sensing result of each of a plurality of the sensing units.

4. The information processing apparatus according to claim 1,
wherein at least a portion of the device held by the holding portion is a device that targets at least a part of the head of the user, and acquires information relating to the target, and
the detection unit detects a deviation in a relative positional relationship between the device and the target, as the deviation.

5. The information processing apparatus according to claim 4,
wherein the device is an imaging unit that, with an eye of the user as an object, captures an image of the object.

6. The information processing apparatus according to claim 1, comprising:
a control unit configured to execute predetermined control in accordance with a detection result of the deviation.

7. The information processing apparatus according to claim 6,
wherein the control unit causes a predetermined output portion to issue notification information in accordance with the detection result of the deviation.

8. The information processing apparatus according to claim 6,
wherein the control unit controls operation relating to a predetermined authentication, in accordance with the detection result of the deviation.

9. The information processing apparatus according to claim 6,
wherein the control unit inhibits execution of a predetermined function, in accordance with the detection result of the deviation.

10. The information processing apparatus according to claim 6,
wherein the control unit controls operation of the device, in accordance with the detection result of the deviation.

11. The information processing apparatus according to claim 1,
wherein the detection unit receives a sensing result from another sensing unit that is provided on the holding portion and is different from the sensing unit, and detects the deviation.

12. The information processing apparatus according to claim 1, comprising:
the holding portion,
wherein the holding portion holds a display portion as at least a portion of the device, in front of the user so as to block at least part of a field of view of the user.

13. The information processing apparatus according to claim 1,
wherein the sensing unit is provided on at least a portion of the holding portion.

14. The information processing apparatus according to claim 1,
wherein the holding portion holds the device to a wearing portion worn on at least a part of the head of the user.

15. The information processing apparatus according to claim 1, comprising:
the sensing unit.

16. An information processing method comprising, by a processor:
acquiring a sensing result from a sensing unit that senses information relating to a holding state of a predetermined device, by a holding portion for holding the device, directly or indirectly, with respect to at least a part of a head of a user; and
detecting a deviation between the holding state of the device and a predetermined holding state set in advance, on the basis of the acquired sensing result.

17. A program causing a computer to execute:
acquiring a sensing result from a sensing unit that senses information relating to a holding state of a predetermined device, by a holding portion for holding the device, directly or indirectly, with respect to at least a part of a head of a user; and
detecting a deviation between the holding state of the device and a predetermined holding state set in advance, on the basis of the acquired sensing result.
